(19) United States
(12) Patent Application Publication
(10) Pub. No.: US 2014/0353490 A1
(43) Pub. Date: Dec. 4, 2014

(54) MASS SPECTROMETRY SYSTEMS AND METHODS FOR IMPROVED MULTIPLE REACTION MONITORING

(71) Applicant: DH Technologies Development Pte. Ltd., Singapore (SG)

(72) Inventors: Stephen Alexander Tate, Barrie (CA); Nicholas Bloomfield, Newmarket (CA); Christopher M. Lock, Richmond Hill (CA)

(73) Assignee: DH Technologies Ptd. Ltd., Singapore (SG)

(21) Appl. No.: 14/369,782

(22) PCT Filed: Nov. 28, 2012
(86) PCT No.: PCT/IB2012/002536

§ 371 Date: Jun. 30, 2014

Related U.S. Application Data
(60) Provisional application No. 61/581,768, filed on Dec. 30, 2011.

(51) Int. Cl. H01J 49/00; H01J 49/42

(52) U.S. Cl. CPC H01J 49/0072; H01J 49/4215
USPC 250/282; 250/288

(57) ABSTRACT

The present teachings are directed to methods and apparatuses for mass spectrometry that include configuring mass spectrometry apparatus to perform a plurality of separate assays on ions fragmented from a given analyte, where each such analysis by the spectrometry apparatus is targeted at a different respective associated mass-to-charge ratio and provides a quantitative measure of the number of fragments thereof.

### RELATED APPLICATIONS

This application claims the benefit and priority from U.S. Provisional Application Ser. No. 61/581,768 filed on Dec. 30, 2011, the entire teachings of which is hereby incorporated by reference.

### FIELD

The disclosure relates to mass spectrometry systems and methods for improved multiple reaction monitoring.

### BACKGROUND

The Applicants relates to mass spectrometry systems and methods for improved multiple reaction monitoring.

With the advent of multiple reaction monitoring (MRM), it has become possible to perform a series of targeted mass spectrometry experiments to achieve high resolution spectroscopy using conventional mass spectrometry equipment. Depending on the operator's needs, such a series of reaction monitoring experiments (each, referred to as single reaction monitoring, or SRM) can provide as much (or more) information as the full scan mass spectroscopy, yet, in less time. Alas, constructing MRM experiments utilizing prior art methologies can be cumbersome.

### SUMMARY

The Applicantssome.cumbersome.me possible to perform a series of targeted mass spectrometry experiments to achieve high resolution spectroscopy using conventional mass spectrometry equipment. Depending on the analyte, where each such assay by the spectrometry apparatus is targeted at a different respective associated mass-to-charge ratio and provides a quantitative measure of the number of fragments thereof.

Related aspects of Applicantse spectrometry apparatus is in which the mass spectrometry apparatus performs the plurality of separate assays successively. Further related aspects of Applicants' teachings provide such methods in which such assays are performed in parallel, e.g., by plural such apparatuses. Still further aspects of Applicants' teachings provide such methods in which such assays are performed, in part, in parallel and, in part, in succession.

Further related aspects of Applicantsch such assays are performe in which the plurality of separate assays comprise a separate assay by the mass spectrometry apparatus targeted to fragments having the mass-to-charge ratio associated with the respective assay.

Still further related aspects of Applicantsapparatus targeted to fragm comprising executing a digital data processor to determine the respective associated mass-to-charge ratios as a function of a molecular structure of the analyte.

Yet further related aspects of Applicantsessor to determine the resp comprising determining the molecular structure from a name of the analyte.

Still yet further related aspects of Applicants from a name of the analyte comprising determining the mass-to-charge ratios as a function of expected fragmentation locations of the analyte.

Other related aspects of Applicants-charge ratios as a functio in which the spectrometry apparatus is a triple quadrupole spectrometer.

Related aspects of Applicantsaratus is a triplde methods comprising performing each of the separate assays on the triple quadrupole spectrometer and utilizing, as among the respective assays, like parameter values for control of a first two quadruples of that spectrometer and different parameter values for control of a third quadrupole spectrometer.

Still further related aspects of Applicantsespective assays, like para wherein the like parameter values comprise a first parameter value (Q1) relating to a mass-to-charge ratio selection by the first quadrupole, a second parameter value (CE) relating to an activation energy utilized by the first quadrupole, and a third parameter value (Q3) relating to a mass-to-charge ratio selection by the third quadrupole.

Other related aspects of the Applicantsting to a mass-to-charge ratio selection by the third quadruird quadrud parameter value (Q3) relating to a mass-to-charge ratio selection by the third quadruirdanalyte; a mass filter that is coupled in an ion flow path with the ion source suitable to select a subset of ions received from the ion source; a reaction region that is coupled in an ion flow path with the mass filter and that can induce dissociation of ions received from the mass filter; and, an ion analyzer that is coupled in an ion flow path with the reaction region and that is suitable to provide a quantitative measure of a number of fragments thereof

These and other aspects of Applicants ion flow path with the ion source suitable to select a subset llows.

### BRIEF DESCRIPTION OF THE DRAWINGS

The skilled person in the art will understand that the drawings, described below, are for illustration purposes only. om the ion source; a reaction region that is coupled in an ion flow path with the mass fil

FIG. 1 depicts a mass spectrometry system in accordance with the Applicants' teachings;

FIG. 2 depicts a workflow in accordance with the Applicantsh the Appliceffected by the mass spectrometry system of FIG. 1;

FIG. 3 depicts a database of the type used in connection with the practice of Applicants' teachings.

### DESCRIPTION OF VARIOUS EMBODIMENTS

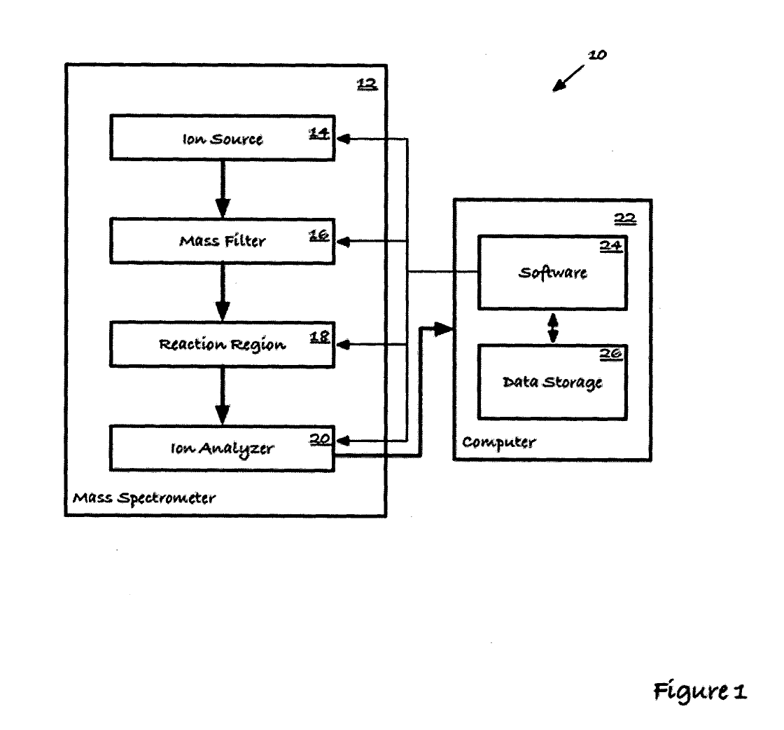

Referring to FIG. 1, illustrated therein is a mass spectrometry system 10 in accordance with some practices of the Applicants ion source; a reaction region that imass spectrometer 12, itself comprising an ion source 14, a mass filter 16, a reaction region 18, and an ion analyzer 20 that are coupled to form a flow-path for the processing and analysis of ions in accord with the teachings hereof. The system further comprises a digital data processor 22 that is electronically coupled with the spectrometer 12 and that includes software 24 and data storage unit 26.

Although the spectrometer 12 and computer 22 are each shown, here, as separate units housing respective constituent components, in some embodiments those components may be housed otherwise. Thus, for example, the computer 22 (or one or more components thereof) may be housed with the spectrometer 12, one or more components of the spectrometer may comprise stand-alone equipment, and so forth, all by way of example. For these reasons, among others, the terms “apparatus” and “system” are used interchangeably herein.

The ion source 14 is configured to emit ions generated from the analyte or sample (not shown) to be analyzed. The ion source is constructed and operated (e.g., by a human operator, computer 22, and/or otherwise) in the conventional manner known in the art of mass spectrometry, as adapted in accord with the teachings hereof. The ion source can include, but is not limited to, a continuous ion source, such as electron impact (EI), chemical ionization (CI), or field desorption-ionization (FD/I) ion sources (which may be used in conjunction with a gas chromatography source); electrospray (ESI) or atmospheric pressure chemical ionization (APCI) ion source (which may be used in conjunction with a liquid chromatography source); desorption electrospray ionization (DESI); or a laser desorption ionization source such as a matrix assisted laser desorption ionization (MALDI), laser desorption-ionization (LDI) or laserspray (which typically utilizes a series of pulses to emit a pulsed beam of ions).

Ions generated by the ion source are transmitted to mass filter 16, which is configured to select (or filter) a subset of ions within a chosen mass-to-charge ratio range and/or based on intensity of the analyte ions for transmission into the reaction region 18. The mass filter is constructed and operated (e.g., by a human operator, computer 22, and/or otherwise) in the conventional manner known in the art, as adapted in accord with the teachings hereof. The mass filter can include, but is not limited to, a quadrupole mass filter, an ion trapping device (such as a 3D or 2D quadrupole ion trap, a C-trap, or an electrostatic ion trap), all by way of example.

Ions emitted by the mass filter 16 are admitted into the region 18 for dissociation by reaction with a reagent gas or gas mixture under a prescribed pressure. The mass filter is constructed and operated (e.g., by a human operator, computer 22, and/or otherwise) in the conventional manner known in the art, as adapted in accord with the teachings hereof. The reaction region 18 can include, but is not limited to, a quadrupole mass filter, an ion trapping device (such as a 3D or 2D quadrupole ion trap, a C-trap, or an electrostatic ion trap), all by way of example.

The ion analyzer 20 is positioned downstream of the ion source and the reaction region in the path of the ions emitted from reaction region 18. Analyzer 20, which may include a detector (not shown) separates the emitted ions and fragments as a function of mass-to-charge ratio (m/z) and generates an output representing counts at or around a designated m/z value. The ion analyzer (and constituent detector) is constructed and operated (e.g., by a human operator, computer 22, and/or otherwise) in the conventional manner known in the art, as adapted in accord with the teachings hereof. The ion analyzer can include, but is not limited to a quadrupole mass filter, an ion trapping device (such as a 3D or 2D quadrupole ion trap, a C-trap, or an electrostatic ion trap), an ion cyclotron resonance trap, an Orbitrap, or a time-of-flight mass spectrometer, all by way of example.

Components 14, 16, 18 and 20 of the spectrometer 12 are coupled by tubing, valves and other apparatus of the type conventionally used in the art to form a flow path suitable for passage and analysis of ions generated by source 14 in accord with the teachings hereof.

Computer 22 comprises a general- or special-purpose digital data processor (stand-alone, embedded or otherwise) of the type known in the art suitable for controlling and/or providing an interface to spectrometer 12, all in the conventional manner known in the art, as adapted in accord with the teachings hereof. Thus, for example, software 24 executes on computer 22 in order to facilitate and/or effect operation of spectrometer consistent with the teachings hereof, and data storage 26 retains one or more databases reflecting the molecular structure of analytes and/or their expected fragmentation locations, as well as of mass-to-charge ratios of the respective fragments thereof, all by way of example.

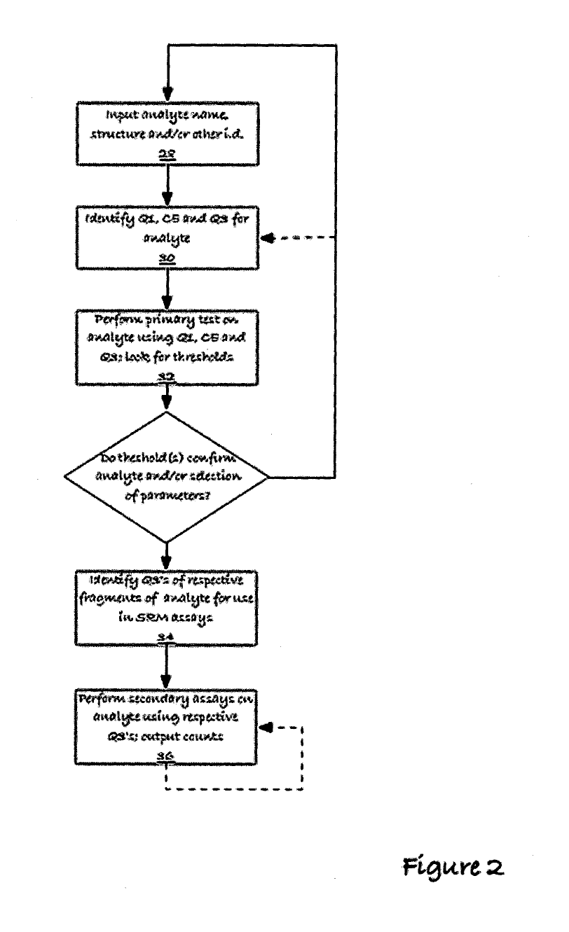

To this end, the computer 22 and/or the operator effect operation of the spectrometer 12 (and, more generally, of the system 10) in accord with the workflow shown in FIG. 2 in order to effect a successive series of quantitative assays (e.g., single reaction monitoring (SRM) assays), each utilizing the ion analyzer 20 to provide a quantitative measure (e.g., a count) of fragments emitted from the reaction chamber at a respective associated mass-to-charge ratio value.

Thus, by way of overview and non-limiting example, in steps 30 and 32, the computer 22 and/or the operator effect operation of the spectrometer 12 to perform a first assay, fragmenting the analyte and measuring resultant ions at one or more mass-to-charge ratio(s). The purpose of this first assay, which is optional, is to generally ensure that the analyte is as identified in step 28, specifically, by fragmenting it using mass filter and reaction chamber parameters suited to the identified analyte and determining whether the reaction products include one or more fragments at expected mass-to-charge ratio(s) for that identified analyte. If not, the assay is treated as having returned a negative result or otherwise (as discussed below). In steps 34 and 36, the computer 22 and/or the operator effect operation of the spectrometer 12 to perform second and subsequent such assays, each (again) fragmenting the analyte using the aforesaid mass filter and reaction chamber parameters and measuring resultant ions at further respective mass-to-charge ratios.

As noted, steps 30 and 32 are optional: in some embodiments, the computer 22 and/or the operator effect operation of the spectrometer 12 to perform steps 34 and 36, e.g., successively, over the entire range of fragmentation products expected to result from mass filter and reaction chamber parameters suited to the analyte identified in step 28.

Referring to the drawing, the computer 22 and, more particularly, the software 24, accepts as input a name, molecular structure and/or other identifier of the analyte. See step 28. Typically, that input is accepted via keyboard or otherwise from a human operator, though it may be supplied from a batch file (e.g., contained in store 26), from apparatus attached to computer 22 or otherwise.

In step 30, the software 24 identifies parameters suitable to drive spectrometer 12 in order to perform a first, or primary, assay on the analyte by (i) effecting fragmentation of the analyte using mass filter and reaction chamber parameters suited to the identified analyte, and (ii) detecting fragmentation products at one or more selected mass-to-charge ratio(s). Those parameters include Q1, a mass selection parameter for mass filter; CE, an activation energy for the reaction chamber 18; and, Q3, a mass selection parameter for the ion analyzer 20.

The software 24 can identify the parameters by using default values (e.g., associated with the class of compound being tested, the operator running the test, and so forth). Alternatively, or in addition, the software can identify the parameters via a lookup in a database contained in store 26 and can be indexed, for example, by analyte name, molecular structure and/or other identifier input in step 28.

The software 24 can also identify those parameters (and, particularly, those respective values of Q3) from the molecular structure of the analyte (which, for some classes of compounds such as peptides is reflected in the compound name). A methodology for making such an identification includes determining fragmentation points along in the compound structure, the charges of the resultant fragments and their respective mass-to-charge ratios.

In step 32, the software 24 and, more generally, the computer 22 operates and/or facilitates operation of (e.g., via a human operator or otherwise) the spectrometer 12 to perform the primary assay on the analyte using the parameters identified in step 30. As noted above, the purpose of this test is to generally ensure that the analyte is as identified in step 28 and, particularly, that it produces at least one of the expected fragmentation products of that identified analyte.

To this end, the computer 22 sets and/or facilitates setting the mass selection parameter for mass filter 16 in accord with Q1 identified in step 30; the activation energy for the reaction chamber 18 in accord with CE identified in that step; and, the mass selection parameter for the ion analyzer 20 in accord with Q3 identified in that step. Deltas or ranges for each of the set parameters and particularly, for example, for Q1 and Q3, can be set at +/−5% or otherwise, depending on practice, convention or other.

Once the parameters are set, the computer 22 executes and/or facilitates execution of an assay on the analyte using those parameters, while monitoring output of the ion analyzer 20 to verify that it has detected peaks or other threshold counts at, for example, a few to several (or more) selected mass-to-charge ratio values characteristic of the analyte. (The software can select those values in the same manner, for example, that it selects parameters in step 30, e.g., based on defaults, database lookup, and/or molecular structure.) If not, the assay is treated as having returned a negative result and processing restarts from the beginning or, alternatively, back to step 28 for input of an alternative name, molecular structure and/or other identifier of the analyte; or to step 30 for selection of alternative parameters for the primary assay.

Otherwise processing proceeds to step 34, whence the software 24 identifies parameters suitable to drive spectrometer 12 to effect a series of further assays (again, for example, single reaction monitoring (SRM) assays) each utilizing the ion analyzer 20 to count (or provide another quantitative measure of) fragments of the analyte generated within the spectrometer 12 for the same values of Q1 and CE as the primary assay, but different respective values of Q3—namely, values of Q3 corresponding to mass-to-charge ratio values of other expected fragments of the analyte.

As above, the software 24 can identify the parameters and, particularly, the respective values of Q3 by using default values, e.g., associated with the class of compound being tested, the operator running the test, and so forth. Alternatively, or in addition, the software can identify the parameters via a lookup in a database contained in store 26 and can be indexed, for example, by analyte name, molecular structure and/or other identifier input in step 28. The software 24 can also identify those parameters (and, particularly, those respective values of Q3) from the molecular structure of the analyte (which, for some classes of compounds such as peptides is reflected in the compound name).

In step 36, the software 24 and, more generally, the computer 22 operates and/or facilitates operation of (e.g., via a human operator or otherwise) the spectrometer 12 to perform a secondary assay on the analyte using the parameters Q1 and CE identified in step 30 and using a successive one of the values of parameter Q3 identified in step 34. The purpose of this test is to provide a quantitative measure of fragmentation of the analyte at the mass-to-charge ratio value corresponding to that particular Q3 (given Q1 and CE). To this end, the computer 22 sets and/or facilitates setting the mass selection parameter for mass filter 16 in accord with the aforesaid Q1, the activation energy for the reaction chamber 18 in accord with aforesaid CE; and, the mass selection parameter for the ion analyzer 20 in accord with the aforesaid Q3. As above, deltas or ranges for each of the set parameters and particularly, for example, for Q1 and Q3, can be set at +/−5% or otherwise, depending on practice, convention or other.

Once the parameters are set, the computer 22 executes and/or facilitates execution of an assay on the analyte using those parameters, while monitoring output of the ion analyzer 20 to obtain counts for the particular Q3 of that assay. It reports the count (e.g., in paper copy, LCD display or otherwise) and logs it, e.g., to store 26.

The software repeats step 36 for each of the values of Q3 identified in step 34 n counts for the particular Q3 of that assay. Itf those values (where the selection is made by the operator or otherwise).

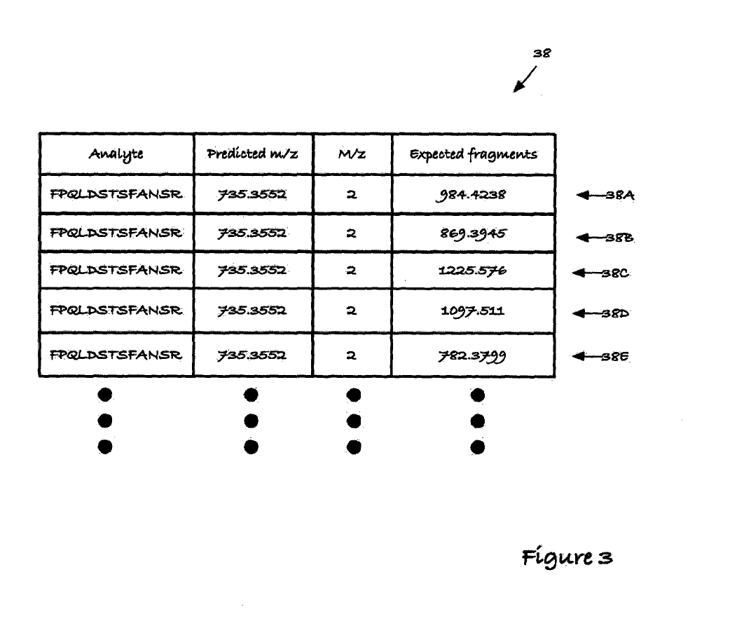

As noted above in connection with step 30 and 34, the software 24 can identify parameters suitable to drive spectrometer 12 to effect above-described assays via a lookup in a database contained in store 26. An example of such a database 38, depicted in FIG. 3, comprises a plurality of records 38A-38E identifying potential ion fragments of an analyte, in this case, the peptide known by the sequence FPQLDSTSFANSR. As shown in the table, that peptide has a mass-to-charge ratio of 2 and is expected to fragment so as to produce a characteristic component having a mass-to-charge ratio of 735.3552 (which can be used in some embodiments in step 30 in connection with generation of parameters for the primary assay) and to produce other components having mass-to-charge ratios of 984.4238, 869.3945, 1225.576, 1097.511 and 782.3799, all by way of non-limiting example (which can be used in some embodiments in step 34 in connection with generation of parameters for the second and subsequent assays). These m/z values for the expected fragment components can be in silico derived from the structure of the peptide.

Described above are systems and methods in accord with the Applicants in the table, thall be appreciated that the embodiments shown in the drawing and discussed above are merely examples and that other embodiments incorporating changes thereto fall within the scope of the Applicants' teachings. Thus, for example, whereas step 36 is describe above and shown in the drawing as being executed in succession for respective values of Q3, that step can be executed in parallel (presuming suitable equipment is available) for some of those values.

1. A method for mass spectrometry comprising
configuring mass spectrometry apparatus to perform a plurality of separate assays on ions fragmented from an analyte,
where each such analysis by the spectrometry apparatus is targeted at a different respective associated mass-to-charge ratio and provides a quantitative measure of fragments at that ratio.

2. The method of claim 1, comprising executing a digital data processor to determine the respective mass-to-charge ratio associated with each analysis as a function of a molecular structure of the analyte.

3. The method of claim 2, comprising determining the molecular structure from a name of the analyte.

4. The method of claim 2, comprising determining the molecular structure from a data lookup.

5. The method of claim 2, comprising determining the mass-to-charge ratios associates with the assays as a function of expected fragmentation locations of the analyte.

6. The method of claim 1, comprising utilizing the mass spectrometry apparatus to perform the plurality of separate assays any of successively; in parallel; and successively, in part, and in parallel, in part.

7. The method of claim 1, in which the plurality of separate assays comprises utilizing the mass spectrometry apparatus to perform a separate assay targeted to fragments having the mass-to-charge ratio associated with that analysis.

8. A method for mass spectrometry comprising
configuring a triple quadrupole spectrometer to perform a plurality of separate assays of daughter ions from the parent compound,
where each such analysis by the spectrometry apparatus is targeted at a different respective associated mass-to-charge ratio and provides a quantitative measure of the number of fragments thereof.

9. The method of claim 8, comprising performing each of the separate assays on the triple quadrupole spectrometer utilizing, as among the respective analysis, like parameter values for control of a first two quadruples of that spectrometer and different parameter values for control of a third quadrupole of that spectrometer.

10. The method of claim 9, wherein the like parameter values comprise
a first parameter value (Q1) relating to a mass-to-charge ratio for isolation in an ion isolating device,
a second parameter value (CE) relating to a fragmentation energy utilized by ion isolated by the first component,
a third parameter value (Q3) relating to a mass-to-charge ratio for either detection or isolation.

11. Apparatus for mass spectrometry comprising
an ion source suitable to generate ions of an analyte;
a mass filter that is coupled in an ion flow path with the ion source suitable to select a subset of ions received from the ion source;
a reaction region that is coupled in an ion flow path with the mass filter and that can be filled with any of an inert gas that induces collision-induced dissociation of ions received from the mass filter and ozone that induces ozone-induced dissociation of such ions;
an ion analyzer that is coupled in an ion flow path with the reaction region and that is suitable to separate any of ions and fragments received from the reaction region as a function of mass-to-charge ratio (m/z) and that provides a quantitative measure of such ions and fragments at a selected such ratio,
the ion source, mass filter, reaction region and ion analyzer being operable to perform a plurality of separate assays on ion fragmented from the analyte, where each such analysis is targeted to provide the quantitative measure at a different respective associated mass-to-charge ratio.

12. The apparatus of claim 11, comprising a digital data processor that determine the respective mass-to-charge ratio associated with each analysis as a function of a molecular structure of the analyte.

13. The apparatus of claim 12, wherein the digital data processor determines the molecular structure from a name of the analyte.

14. The apparatus of claim 12, wherein the digital data processor determines the molecular structure from a data lookup.
